(19) United States
(12) Patent Application Publication
(10) Pub. No.: US 2023/0249221 A1
(43) Pub. Date: Aug. 10, 2023

(54) WOOD CHIP SORTER SCREEN AND RELATED METHODS OF SORTING WOOD CHIPS

(71) Applicant: Aqseptence Group, Inc., New Brighton, MN (US)

(72) Inventors: Ehrich Shaw, New Brighton, MN (US); Brent J. Skadsen, Vancouver, WA (US)

(21) Appl. No.: 18/012,609

(22) PCT Filed: Jun. 21, 2021
(86) PCT No.: PCT/US2021/038240

§ 371 Date: Dec. 22, 2022

Related U.S. Application Data
(60) Provisional application No. 63/042,222, filed on Jun. 22, 2020.

(51) Int. Cl. B07B 1/12; B07B 1/46; B07B 1/04

(52) U.S. Cl. CPC B07B 1/12; B07B 1/4672; B07B 1/469; B07B 1/04

(57) ABSTRACT

A chip sorting screen utilizing a plurality of shaped wire elements sized and spaced to allow for efficient sorting of wood chips and fiber elements. The chip sorting screen includes an upper surface formed of shaped wire elements arranged in parallel relationship to define slots between adjacent shaped wire elements. Each shaped wire element is mounted to a support member 10 define an upper surface. The mounting orientation of the shaped ware element to the support members can be consistent along a screen length or alternatively, the mounting orientation can change along the screen length to selectively vary sorting performance by varying slot size along the sorting screen. A height of each shaped wire element or an angle by which a leading edge of the shaped wire element is presented to the conveying path, can be selectively adjusted to increase wood chip turbulence across the sorting screen.

### PRIORITY CLAIM

The present application claims priority to U.S. Provisional Application Ser. No. 63/042,222, filed Jun. 22, 2020 and entitled “WOOD CHIP SORTER SCREEN AND RELATED METHODS OF SORTING WOOD CHIPS”, which is hereby incorporated by reference in its entirety.

### FIELD OF THE INVENTION

The present disclosure relates generally to screen panels for sorting wood chips by size for subsequent processing. More specifically, the present disclosure is directed to screen panels fabricated using shaped wire at desired orientations to improve sorting efficiency.

### BACKGROUND

Paper and pulp manufacturers have long recognized that the quality of their final products is highly dependent upon the consistency of the initial wood chips used in their process. In order to achieve high product quality, these manufacturers have developed two-stage sorting processes to sort wood chips by size using processes that can include conveying woodchips across a sorting surface, where the sorting surface itself can be manipulated, for example, by vibration, oscillation and/or rotation to agitate the wood chips across -the sorting surface. The first stage sorts out the overs, that is wood chips too large to efficiently process into wood fibers or wood fiber bundles. The second stage removes the fines, pins and grid from the wood chips that will continue into the pulping process. Conventional second stage for fines screening can include screens that utilize perforated plate or woven wire mesh, each having holes or apertures that are sized such that the undesirable sized woods chips can pass through the sorting surface and are thus removed from the pulping process.

Conventional fine screen/second stage sorting surfaces are subject to failure, for example, by plugging of the holes/apertures or by actual damage to the holes/apertures that can increase the size of the holes/apertures. When the holes/apertures of the sorting surface are plugged, undesirable sized wood chips including thin slivers of wood or “pins” are prevented from passing thorough the apertures and are instead, carried over to the next stage of the pulping operation. When the holes/apertures are enlarged due to damage, wood chips that would otherwise be ideal for the pulping process are instead allowed to pass through the sorting surface along with the undesirable materials, which leads to a reduced yield relative to raw materials used in the actual pulping process.

In view of the problems with conventional sorting surface technology, it would be advantageous to have an improved design that provides desirable sorting characteristics and is resistant to damage and plugging.

### SUMMARY

In representative embodiments of the present disclosure, there is provided a wood chips sorting panel utilizing a plurality of shaped wire elements that are sized and spaced to allow for efficient sorting of wood chips. In a preferred embodiment, the shaped wired elements can comprise wedge wire or Vee-Wire® shaped wire elements that are arranged in a parallel relationship so as to define sorting slots between adjacent shaped wire elements. The sorting screen can be incorporated into a sorting machine, for example, a gyratory sorting machine, such that the sorting slots are presented in a desired relation to a conveying path of the wood chips across the sorting machine. The mounting orientation of the shaped wire element to the support members can be the same along the length of the sorting screen or alternatively, the mounting orientation can change along the length of the sorting screen so as to selectively vary sorting performance for example, by varying slot size, along the sorting screen. Varying the mounting orientation can also selectively adjust a height of each shaped wire element or an angle by which a leading edge of the shaped wire element is presented to the conveying path to increase wood chip turbulence across the sorting screen and provide a self-cleaning function. In some embodiments, the shaped wire elements can be coated or otherwise machined/treated to enhance long term operation and wear that can be dependent on wood chip type or moisture content.

In one aspect, the present invention is directed to a chip sorting screen comprising a screen top and a screen bottom that are spaced apart and supported by a screen frame. Chip sorting screen can generally define an upstream end and a downstream end. The screen top generally comprises a plurality of shaped-wire elements that are operably coupled to one or more support members. The shaped-wire elements are arranged so as to lie in a generally parallel relationship to each other and separated by a slot width so as to define essentially continuous slots along the screen top. The shaped-wire elements and sorting slots can reside in transverse relationship relative to a woodchip flow direction from the upstream end to the downstream end. Preferably, the shaped-wire elements comprise a wedge or Vee-wire® element that has a vee-shaped or triangular cross-section. The screen bottom can comprise a woven wire sheet defining a plurality of square-shaped openings or alternatively, other screen material known in the art can be used.

In another aspect, the present invention is directed to a method of sorting a wood chip stream. Generally, the method can comprise passing a wood chip stream across a chip sorting screen having a top surface formed of a plurality of shaped wire elements arranged in parallel so as to define a plurality of slots. The method can further comprise disrupting the wood chip stream with a leading edge of each shaped wire element to form a turbulent or washboard action across the top surface whereby wood chip fines, pins and grit are directed through the slots.

In yet another aspect, the present invention is directed to a sorting screen assembly for use with a sorting machine. The sorting screen assembly can comprise a plurality of chip sorting screens that are arranged to influence the travel path of a wood chip stream. In some embodiments, the use of a plurality of chip sorting screens can allows for a change in slot angle relative to the wood chip stream. Generally, each chip sorting screen can be configured such that slots defined on each chip sorting screen reside in a non-transverse relationship to the wood chip stream. The slots on each chip sorting screen can reside in a parallel or non-parallel relationship to each other as well as combinations of parallel and non-parallel slots.

The above summary is not intended to describe each illustrated embodiment or every implementation of the subject matter hereof. The figures and the detailed description that follow more particularly exemplify various embodiments.

### BRIEF DESCRIPTION OF THE FIGURES

Subject matter hereof may be more completely understood in consideration of the following detailed description of various embodiments in connection with the accompanying figures, in which:

FIG. 1 is a top perspective view of an embodiment of a chip sorting screen of the present invention.

FIG. 2 is a bottom perspective view of the chip sorting screen of FIG. 1.

FIG. 3 is a top view of the chip sorting screen of FIG. 1.

FIG. 4 is a side view of the chip sorting screen of FIG. 1.

FIG. 5 is a section view taken at lines A-A of FIG. 3.

FIG. 6 is a section view taken at lines B-B of FIG. 3.

FIG. 7 is a section view taken at lines C-C of FIG. 3.

FIG. 8 is a section view taken at lines D-D of FIG. 3.

FIG. 9 is a section view taken at lines E-E of FIG. 3.

FIG. 10 is a side view of a representative screen top illustrating a variety of potential configurations.

FIG. 11 is a side view of a representative screen top illustrating a chip flow across an upper surface of the chip sorting screen of the present invention.

FIG. 12 is a side view of a representative screen top of the chip sorting screen of the present invention.

FIG. 13 is atop view of the chip sorting screen of FIG. 1.

FIG. 14 is a top view of a portion of a bottom screen formed from woven wire screen.

FIG. 15 is a top view of a portion of a bottom screen formed from a punched plate.

FIG. 16 is a side view of a representative screen top illustrating sorting of a wood chip stream.

FIG. 17 is a top view of a chip sorting screen formed of a plurality of screen segments.

FIG. 18 is a top view of a chip sorting screen thrilled of a plurality of screen segment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE FIGURES

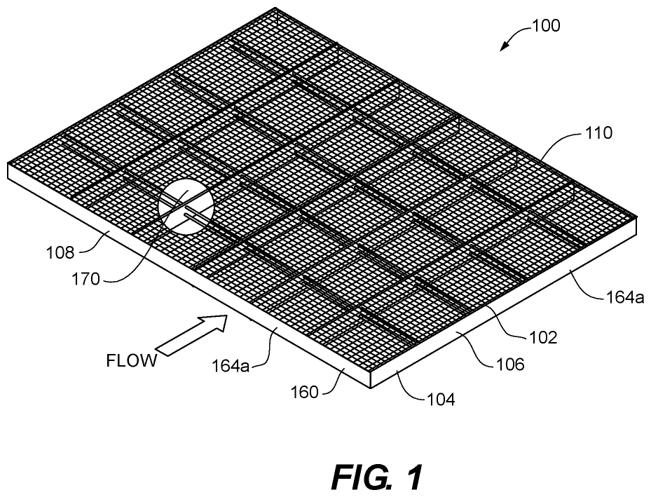

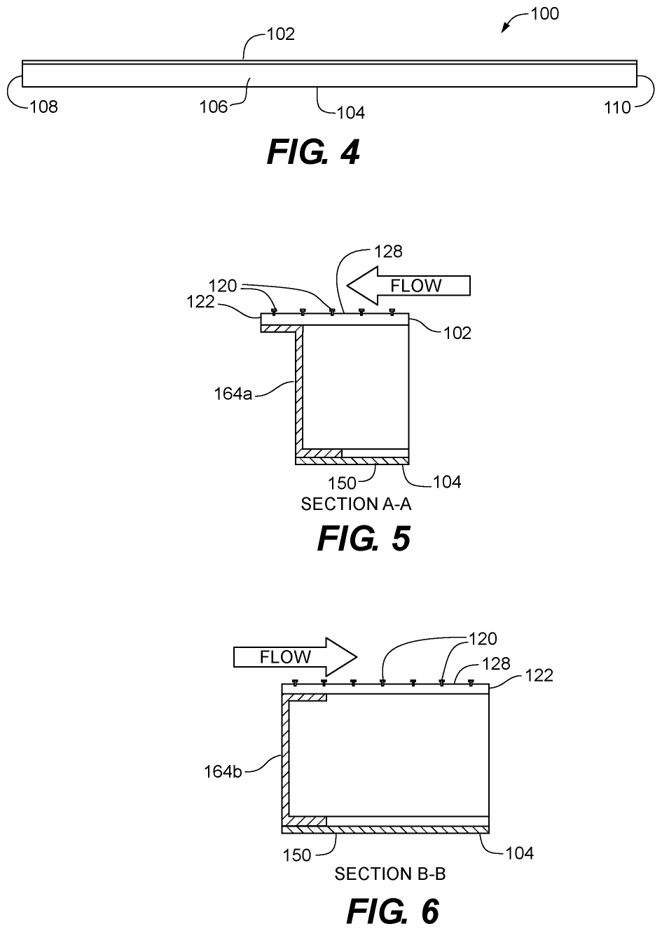

A representative embodiment of a chip sorting screen 100 is illustrated in FIGS. 1, 2, 3 and 4. Generally, chip sorting screen 100 comprises a screen top 102 and a screen bottom 104 that are spaced apart and supported by a screen frame 106. Generally, the components of screen 100 can be fabricated of a suitable metallic material exhibiting strength and durability. Suitable materials can include one or more of carbon steel, galvanized steel, stainless steel, aluminum and combinations thereof. Chip sorting screen 100 generally defines an upstream end 108 and a downstream end 110.

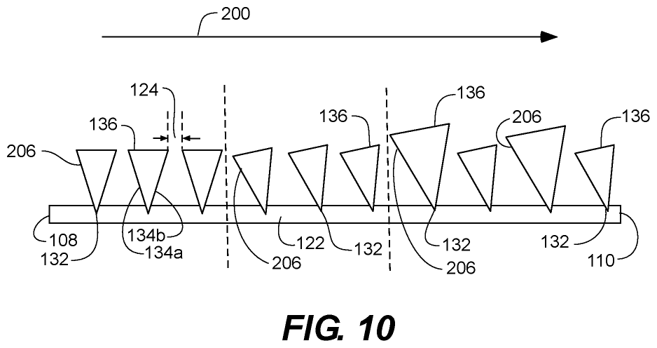

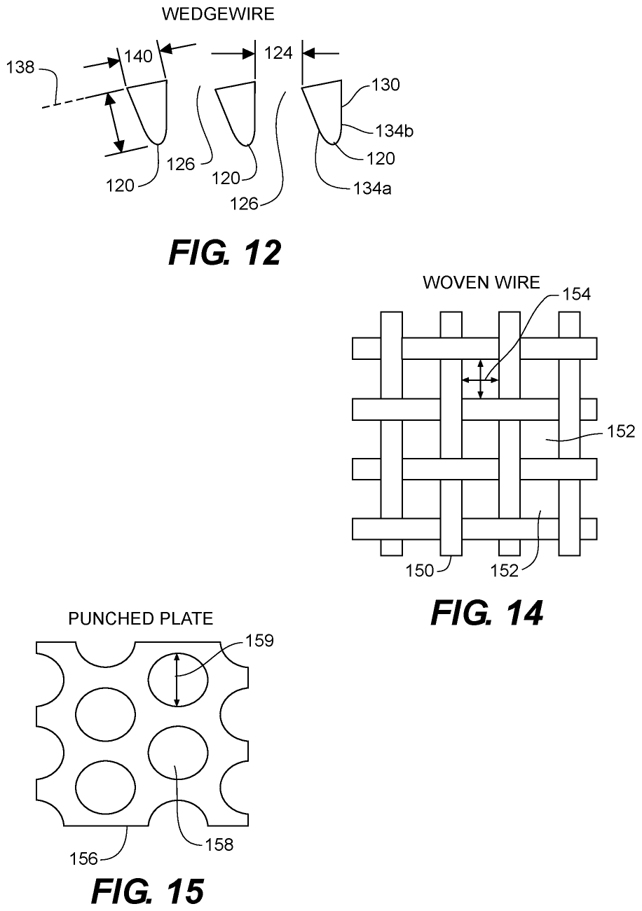

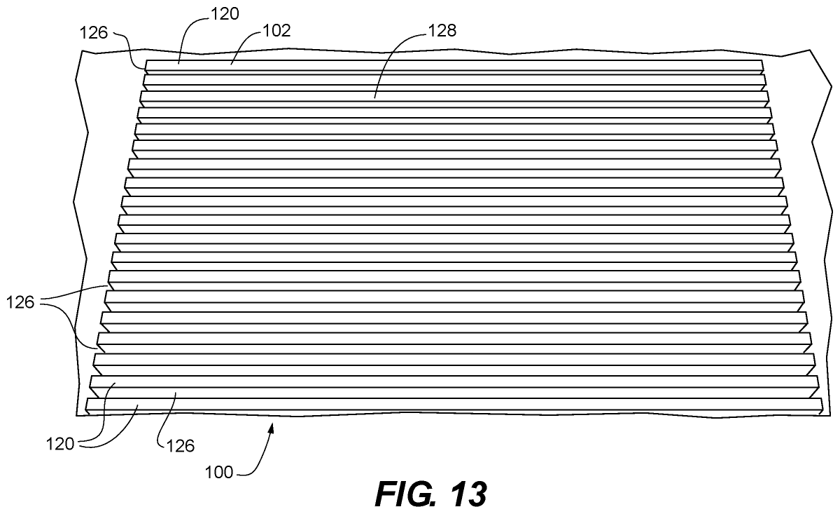

As illustrated in FIGS. 1 and 3-9, screen top 102 generally comprises a plurality of shaped-wire elements 120 that are operably coupled to one or more support members 122. As shown generally in FIGS. 10-13, the shaped-wire elements 120 are arranged so as to lie in a generally parallel relationship to each other and separated by a slot width 124 so as to define essentially continuous slots 126 along an upper surface 128 of the screen top 102. The shaped-wire elements 120 and slots 126 can reside in transverse relationship relative to a flow direction from upstream end 108 and downstream end 110. Preferably, the shaped-wire elements 120 comprise a wedge or Vee-wire® element that has a vee-shaped or triangular cross-section 130 as seen in FIGS. 10-12. The triangular cross-section 130 generally defines an attachment point 132, a pair of wire sides 134a, 134b and an element surface 136. Element surface 136 has a generally flat surface defining an element plane 138 and an element width 140 defined between the intersections with the wires sides 134a, 134b. The shaped-wire elements 120 are attached to the support members 122 at attachment point 132 by welding the shaped-wire elements 120 in a perpendicular orientation to the support members 122. Typically, the shaped-wire elements 120 can be attached to the support members 122 based on the same principles as disclosed in U.S. Pat. Nos. 6,663,774 and 7,425,264, both of which are hereby incorporated by reference in their entirety.

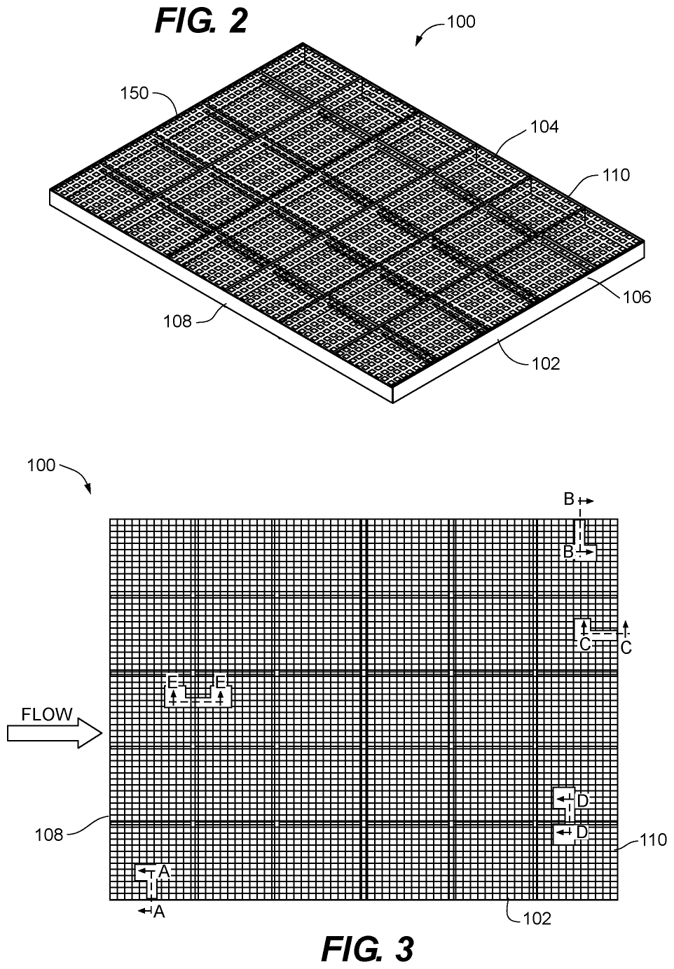

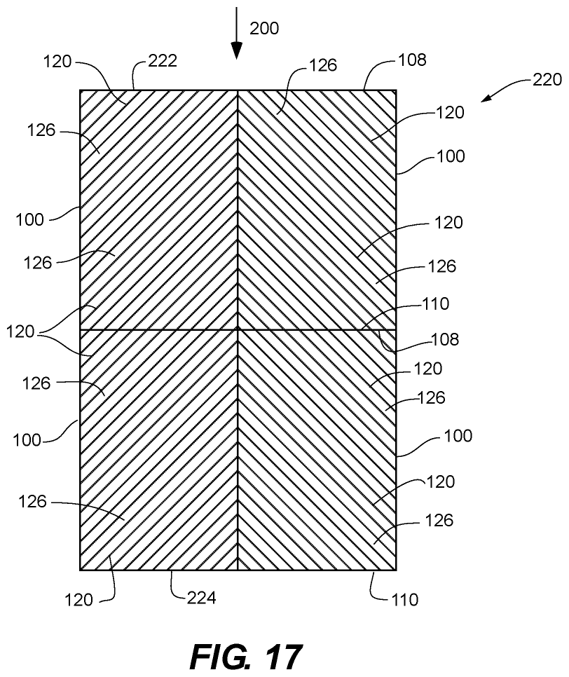

As illustrated in FIGS. 2, 5-9 and 14, screen bottom 104 generally comprises a woven wire sheet 150 defining a plurality of square-shaped openings 152. Generally, the square-shaped openings 152 have an interior length 154, wherein interior length 154 exceeds the slot width 124. In an alternative embodiment, screen bottom 104 can comprise a punched plate sheet 156 defining a plurality of circular or rounded openings 158 as shown in FIG. 15. The circular or rounded openings 158 can have an internal diameter 159 that exceeds slot width 124.

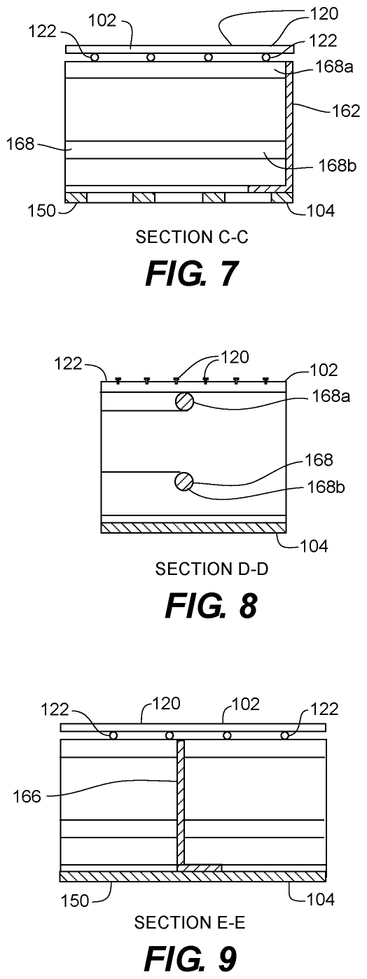

Referring now to FIGS. 1, 2 and 4-9, screen frame 106 generally comprises an upstream frame member 160, a downstream frame member 162, and a pair of side frame members 164a, 164b, wherein upstream frame member 160 and downstream frame member 162 correspond with upstream end 108 and downstream end 110 respectively. The upstream and downstream frame members 160, 162 can comprise L-shaped angle members as seen in FIG. 7 while the side frame members 164a, 164b can comprise S-channel or C-channel members as seen in FIGS. 5 and 6. Screen frame 106 can further comprise a plurality of internal frame members 166 that extend between the side frame members 164a, 164b and reside in generally parallel relationship to the upstream and downstream frame members 160, 162 as illustrated in FIG. 9. In some embodiments, a plurality of internal retention rods 168 can be positioned between the upstream frame member 160 and downstream frame member 162 that cooperatively with the internal frame members 166 define a plurality of frame pockets 170 within the chip sorting screen 100. In some embodiments, the screen top 102 can be at least partially supported by an upper internal retention rod 168a as seen in FIGS. 7 and 8 while a lower internal retention rod 168b lies in parallel relationship but closer to the screen bottom 104. Each frame pocket 170 is generally constrained by the screen top 102, the screen top 104 and on all four sides by either the upstream frame member 160, the downstream frame member 162, the side frame members 164a, 164b, the internal frame members 166 and/or the internal retention rods 168 depending on where the individual frame pocket 170 resides within the chip sorting screen 100. In some embodiments, one or more ceramic balls can reside and be constrained within each frame pocket 170. Generally, the distance between upper internal retention rod 168a and lower internal retention rod 168b is less than a diameter of each ceramic ball.

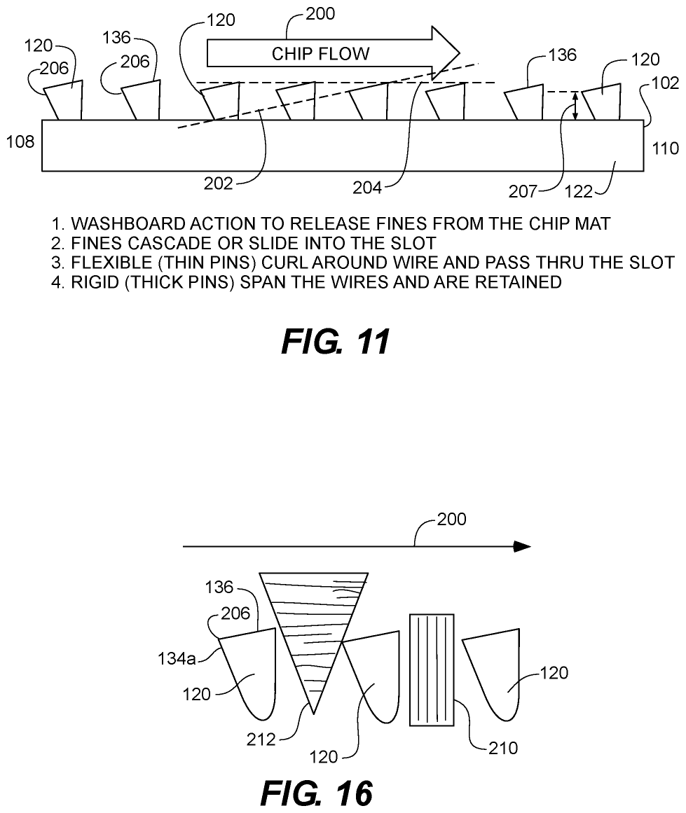

In use, one or more chip sorting screens 100 are incorporated into a gyratory screener following the rough sorting of the original wood chips. Following the rough sorting of the original wood chips, chip sorting screen 100 is used to sort wood chips by size and to separate the desirable long fibers, which are ideal for further pulp processing, from the fines and shorter fibers, which hinder liquor removal from a digester. Generally, a wood chip stream 200 is directed across the chip sorting screen 100 from the upstream end 108 to the downstream end 110 as shown schematically in FIGS. 10 and 11. As best seen in FIG. 11, each shaped-wire element 120 can be attached to the one or more support members 122 such that the individual element surfaces 136 do not reside in the same plane but instead, define an element plane 202 that is angled with respect to a support plane 204 defined by the support members 122. In some embodiments, element plane 202 can be consistent for each shaped-wire element 120 or alternatively, the element plane 202 can be selectively varied between the upstream end 108 and downstream end 110 as seen in FIG. 10 to promote desired sorting performance across the chip sorting screen 100. Furthermore, as seen in FIG. 10, sizes of the shaped-wire elements 122 can be varied or alternated between the upstream end 108 and downstream end 110 to achieve desired sorting performance.

As the wood chip stream 200 encounters wire side 134a, a leading edge 206 of the element surface 136 interacts with the wood chip steam 200 and introduces a washboard action that agitates the individual chips to release chip fines 210 from the wood chip stream 200. The smallest chip fines 210 pass directly through the slots 126 and into the pockets 170 as shown in FIG. 16. Flexible wood chips that would otherwise be too large to pass directly through slots 126 curl around the shaped-wire elements 120 and pass through the slots 126 and into pockets 170. Larger, rigid wood chips 212 that are the most desired chips for feeding into a digester cannot pass through the slots 126 and are retained on the screen top 102. The fines and flexible wood chips within pockets 170 can then pass through the openings 152 on the woven wire sheet 150. In the event that the flexible woods chips are too large to pass directly through the openings 152, the one or more ceramic balls within each pocket 170 can interact with the wood chips to break or grind them into smaller pieces that can fit through the openings 152. By removing the fines 210 and flexible pin chips and feeding only the larger, rigid pin chips 212 to the digester, void spaces within the digester are maintained and liquor removal from the digester is enhanced, resulting in higher efficiencies and quality. Referring to FIG. 11, the leading edge 206 can define a leading edge height 207 relative to the support member 122 that defines how the leading edge 206 interacts with, “cuts” into and disrupts wood chips stream 200. In some embodiments, the leading edge height 207 of each shaped wire element 120 can be the same along the screen top 102 or alternatively, the leading edge height 207 can be varied across the screen top 102 and between the upstream end 108 and downstream end 110 to induce a desired washboard action across the screen top 102.

During use of the chip sorting screen 100, wood chips that have at least one dimension larger than the slot width 124 can become trapped within the rectangular shaped slots 126. As opposed to rectangular or round shaped openings, the rectangular shaped slots 126 are essentially bound on only two sides, for example, between adjacent shaped-wire elements 120. Thus, chip sorting screen 100 is easily cleaned with high pressure water sprayed along the screen top 102. As these trapped wood chips are only retained on two sides, they can shift and move more easily than wood retained around their entire perimeter, thereby allowing them to be dislodged easier and to clear the screen top 102 faster such that the gyratory or similar screening machine experiences less downtime when using chip sorting screen 100.

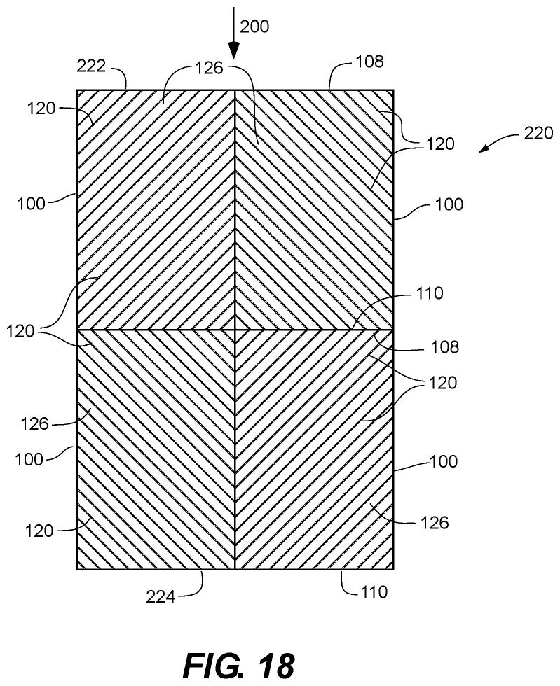

With reference to FIGS. 17 and 18, a gyratory screener can utilize a sorting screen assembly 220 formed of a plurality of chip sorting screens 100 defining an assembly upstream end 222 and an assembly downstream end 224. The sorting screen assembly 220 can be assembled such that the orientation of the rectangular shaped slots 126 of each chip sorting screen 100 can be arranged in a non-transverse orientation relative to the wood chip stream 200 and in a non-parallel orientation relative to each other. By selectively arranging the configuration of the rectangular shaped slots 126 relative to the wood chip stream 200, the agitation or washboard action of the wood chip stream 200 can be enhanced when the wood chip stream 200 encounters the leading edge 206 of each shaped-wire element 120.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

1. A wood chip sorting screen, comprising:
a screen frame defining an upstream end, a downstream end, an upper surface and a lower surface, the upper surface comprising a plurality of spaced apart shaped wire elements residing in parallel alignment so as to define a plurality of continuous slots between adjacent shaped wire elements, the lower surface comprising a sheet defining lower openings, said lower openings defining an opening width greater than a slot width between adjacent shaped wire elements.

2. The wood chip sorting screen of claim 1, wherein the shape wire elements comprise wedge wire or Vee® wire elements.

3. The wood chip sorting screen of claim 2, wherein each wedge wire or Vee® wire element defines a generally triangular cross-section defining an attachment point, a pair of wire sides and an element surface.

4. The wood chip sorting screen of claim 3, wherein the attachment point of each wedge wire or Vee® wire element is attached to one or more support members.

5. The wood chip sorting screen of clam 4, wherein the element surface of each shaped-wire element defines an element plane.

6. The wood chip sorting screen of claim 5, wherein the element plane of each shaped wire element resides in a non-parallel orientation to a support plane defined by the one or more support members.

7. The wood chip sorting screen of claim 5, wherein the element plane of each shaped wire element resides in a parallel orientation to a support plane defined by the one or more support members.

8. The wood chip sorting screen of claim 5, wherein the element plane of each shaped wire element varies between the upstream end and the downstream end.

9. The wood chip sorting screen of claim 3, wherein the element surface defines a leading edge of each shaped wire element that faces the upstream end, said leading edge defining a leading edge height.

10. The wood chip sorting screen of claim 10, wherein the leading edge height is the same for each shaped wire element between the upstream end and the downstream end.

11. The wood chip sorting screen of claim 10, wherein the leading edge height of at least one of the shaped wire elements is different than other shaped wire elements between the upstream end and the downstream end.

12. The wood chip sorting screen of claim 3, wherein the element surface defines an element width between the pair of wire sides.

13. The wood chip sorting screen of claim 12, wherein the element width of each shaped wire element is the same between the upstream end and the downstream end.

14. The wood chip sorting screen of claim 12, wherein the element width of at least one of the shaped wire element varies from other shaped wired elements between the upstream end and the downstream end.

15. The wood chip sorting screen of claim 1, wherein the parallel alignment of the plurality of spaced apart shaped wire elements is in perpendicular alignment to a wood chip flow across the upper surface from the upstream end to the downstream end.

16. The wood chip sorting screen of claim 1, wherein the parallel alignment of the plurality of spaced apart shaped wire elements is in an angled alignment to a wood chip flow across the upper surface from the upstream end to the downstream end.

17. The wood chip sorting screen of claim 1, wherein the slot width between each of the continuous slots is the same between the upstream end and the downstream end.

18. The wood chip sorting screen of claim 1, wherein the slot width of at least one of the continuous slot is different than the other continuous slots between the upstream end and the downstream end.

19. A wood chip sorting screen assembly, comprising:
at least two wood chip sorting screens according to any of claims 1-18, wherein the at least two wood chip sorting screens are coupled together to cooperatively define a system upstream end and a system downstream end relative to a wood chip flow stream.

20. The wood chip sorting screen assembly of claim 19, wherein the plurality of continuous slots on each wood chip sorting screen reside in a parallel relation.

21. The wood chip sorting screen assembly of claim 19, wherein the plurality of continuous slots on each wood chip sorting screen reside in a non-parallel relation.

22. The wood chip sorting screen assembly of claim 19, wherein the plurality of continuous slots reside in a perpendicular orientation relative to the wood chip flow stream.

23. The wood chip sorting screen assembly of claim 19, wherein the plurality of continuous slots on at least one of the wood chip sorting screens reside in a non-parallel orientation relative to the wood chip flow stream.

24. A method of sorting wood chips comprising:
directing a wood chip stream across the upper surface of a wood chip sorting screen according to any of claims 1-18, said wood chip stream including larger, rigid wood chips and smaller fines and smaller wood slivers; and
retaining the larger, rigid wood chips on the upper surface, whereby the larger rigid wood chip are directed to a digestor for further pulp processing.

25. The method of claim 24, further comprising:
passing the smaller fines and smaller wood silvers through the continuous slots on the upper surface such that the smaller fines and smaller wood slivers can be removed from the wood chip stream through the lower openings on the lower surface.
